(19) United States
(12) Patent Application Publication
(10) Pub. No.: US 2006/0035036 A1
(43) Pub. Date: Feb. 16, 2006

(54) Anisotropic conductive adhesive for fine pitch and COG packaged LCD module

(75) Inventors: Myung Jin Yim, Daejeon-city (KR); Jin Sang Hwang, Daejeon-city (KR)

Correspondence Address: ROTHWELL, FIGG, ERNST & MANBECK, P.C., 1425 K STREET, N.W., SUITE 800, WASHINGTON, DC, 20005, US

(73) Assignee: TELEPHUS INC., Daejeon-city (KR)

(21) Appl. No.: 10/918,406

(22) Filed: Aug. 16, 2004

(51) Int. Cl. C09K 19/00

(52) U.S. Cl. 428/1.1; 428/209

(57) ABSTRACT

Provided are an anisotropic conductive adhesive (ACA) for a fine pitch including conductive particles and non-conductive particles, and a chip-on-glass (COG) packaged liquid crystal display (LCD) module including the ACA. The sizes of the conductive particles and non-conductive particles in the ACA are adjusted according to a gap between electrodes of fine pitch arranged on a glass substrate of the LCD module. The provided ACA for a fine pitch is used for connecting the IC onto the glass substrate such as to electrically connect the IC to the electrodes. The provided ACA includes a thermosetting resin, a curing agent for curing the thermosetting resin, a plurality of conductive particles having an average diameter of less than half of a gap between the electrodes, the plurality of conductive particles being included at a first dispersion density, and a plurality of non-conductive particles having an average diameter of less than half of the average diameter of the conductive particles, the plurality of conductive particles being included at a second dispersion density that is larger than the first dispersion density.

### BACKGROUND OF THE INVENTION

1. Field of the Invention

The present invention relates to an anisotropic conductive adhesive (ACA) and a liquid crystal display (LCD) module including the same, and more particularly, to an ACA used for connecting a driving integrated circuit (IC) to a glass substrate having electrodes of a fine pitch and a chip-on-glass (COG) packaged LCD module in which a driving IC for driving an LCD is packaged on an LCD panel by a COG method.

2. Description of the Related Art

Methods for packaging a driving IC on an LCD panel are generally classified as one of a wire bonding method in which a driving IC connects LCD panel electrodes via conductive wires, a tape automated bonding (TAB) method in which a driving IC is packaged on electrodes of an LCD panel by using a base film, and a COG method in which a driving IC is directly packaged on an LCD panel by using a predetermined adhesive. Here, the COG package method has the advantages of minimizing a package area and reducing cost, and thus the COG package method has been used increasingly. Generally, an ACA is used for electrically connecting electrodes on an LCD panel and electrodes of a driving IC, in connecting the LCD panel and the driving IC by a COG package method.

Recently, in order to meet demands for high capacity and high-quality images, the size of LCD panels has been increasing while the size of electrodes has been decreasing. Accordingly, the width and thickness of signal lines on an LCD panel has been decreasing along with the area of electrodes or bumps for electrically connecting an LCD panel and a driving IC, so that a pitch or a distance between electrodes decreases. Substantially, the pitch between bumps or electrodes in a COG packaged LCD module used in a monitor for a personal computer (PC) or a cellular phone is about 100 μm, and the distance between the electrodes is about 50 μm. Furthermore, the pitch and the distance are continuously decreasing.

Therefore, an ACA for electrically connecting a great number of electrodes within a limited area and strongly maintaining the adhered structure of an LCD panel and a driving IC is required.

However, a conventional ACA is limited in its ability to be used in connecting a driving IC onto an LCD panel having electrodes of a fine pitch and increases electrical resistance between bumps. This is because the size and number of mobile charge carriers that transmit electrical signals in the conductive adhesive are limited, thus limiting electrical conductivity. Consequently, in order to improve electrical conductivity, the number of mobile charge carriers (hereinafter referred to as conductive particles) in the ACA has to be increased. However, when the number of conductive particles simply increases in the ACA, the electrical resistance is lowered but the large number of conductive particles is likely to cause a short circuit. A method of reducing the size of conductive particles to transmit electrical signals by using a larger number of conductive particles has been introduced to overcome the above problems. However, since the conductive particles have to satisfy conditions of appropriate electrical conductivity and elasticity, and evenness in size and shape, reduction in the size of the conductive particles requires high technology, thereby increasing the cost of producing the ACA.

FIG. 1 is a sectional view illustrating a structure where a glass substrate 10 of an LCD panel and a driving IC 20 are connected in a COG package manner by using a conventional ACA. Referring to FIG. 1, indium tin oxide (ITO) electrodes 12 on a glass substrate 10 and bumps 22 of a driving IC 20 have a width of about 25 μm and a pitch of about 50 μm. In addition, the height of the electrodes 12 on the glass substrate 10 is about 1 μm and the height of the bumps 22 on aluminum (Al) electrodes (not shown) of the driving IC 20 is about 25 μm.

In an adhesion process of the glass substrate 10 and the driving IC 20, resin and conductive particles 32 of an ACA 30 between the bumps 22 and the electrodes 10 receive heat and pressure. Accordingly, the viscosity of the ACA 30 is lowered so that the resin and conductive particles 32 flow into the spaces between the bumps 22. Here, since the space between two adjacent bumps 22 is larger than the space between an electrode 12 and the bump 22 across from it, there are fewer conductive particles 32 between the bump 22 and the electrode 12 than between the adjacent bumps 22. Consequently, the resistance between the electrode 12 and the bump 22 increases causing current to be conducted through the conductive particles 32 between the bumps 22, thereby shorting out the bumps 22. Here, as the size and content of the conductive particles 32 increase, the bumps 22 become more easily shorted.

FIG. 2 is a sectional view illustrating misalignment between a glass substrate 10 of an LCD panel and a driving IC 20 connected in a COG package manner by using a conventional ACA. Generally, a misalignment margin is about 10% of the pitch of electrodes 12. Accordingly, the misalignment margin for the LCD module shown in FIG. 1 is about 5 μm. When a misalignment of 5 μm occurs, a maximum width for conduction between electrodes 12 and bumps 22 via conductive particles 32 is about 10 μm. As a result, electrical signals cannot be properly transmitted between the electrodes 12 and the bumps 22. In addition, the distance between bumps 22 and non-adjacent electrodes 12 is reduced, thereby increasing the likelihood of a short circuit.

### SUMMARY OF THE INVENTION

The present invention provides an anisotropic conductive adhesive (ACA) for stably, reliably, and cost effectively connecting a driving integrated circuit (IC) onto a liquid crystal display (LCD) panel having a large size and fine electrodes.

The present invention also provides a chip-on-glass (COG) packaged LCD module in which an LCD panel having electrodes of a fine pitch for providing a large capacity and high quality images is stably and reliably connected to a driving IC for driving the LCD device, without possibility of short circuiting through conductive particles.

According to an aspect of the present invention, there is provided an ACA for fine pitch, used to connect an IC onto a glass substrate having a plurality of electrodes arranged with a predetermined interval and electrically connect the IC to the electrodes, comprising a thermosetting resin, a curing agent for curing the thermosetting resin, a plurality of conductive particles having an average diameter of less than half of a gap between the electrodes of the glass substrate, the plurality of conductive particles being included at a first dispersion density, and a plurality of non-conductive particles having an average diameter of less than half of the average diameter of the conductive particles, the plurality of non-conductive particles being included at a second dispersion density that is larger than the first dispersion density.

It is preferable that the conductive particles have an average diameter of less than one third of the gap between the electrodes of the glass substrate and the non-conductive particles have an average diameter of half to one tenth of the average diameter of the conductive particles.

It is preferable that the dispersion density of the conductive particles is twenty thousand to fifty thousand particles per mm², and the dispersion density of the non-conductive particles is sixty thousand to one hundred and eighty thousand particles per mm². It is preferable that the dispersion density of the non-conductive particles is two to six times greater than the dispersion density of the conductive particles.

Here, the conductive particles may be formed of metal powder or polymer beads coated with metal and the non-conductive particles may be formed of a polymer or a ceramic. For example, the non-conductive particles are formed of one material selected from the group consisting of Teflon, polyethylene, alumina, silica, glass, and silicon carbide.

According to another aspect of the present invention, there is provided a COG packaged LCD module comprising a transparent glass substrate having a plurality of electrodes arranged with a predetermined interval, a driving IC having input/output (I/O) bumps arranged to correspond the electrodes, an ACA interposed between the glass substrate and the driving IC to adhere the glass substrate and the driving IC, and a plurality of conductive particles having an average diameter of less than half of a gap between the electrodes, the plurality of conductive particles being included at a first dispersion density to maintain electrical connection between the electrodes and the I/O bumps. Here, the ACA includes a plurality of non-conductive particles having an average diameter of less than half of the average diameter of the conductive particles, wherein the plurality of non-conductive particles are included at a second dispersion density which is larger than the first dispersion density.

According to the present invention, an ACA including conductive particles and non-conductive particles having sizes adjusted according to a gap between electrodes of a fine pitch is used so that a driving IC can be stably and reliably connected to an LCD panel having a large size and fine electrodes. In addition, a COG packaged LCD module in which an LCD panel having electrodes of a fine pitch and a driving IC for driving an LCD device are stably and reliably connected without possibility of short circuiting through conductive particles, is obtained.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view illustrating a structure in which a glass substrate of a liquid crystal display (LCD) panel and a driving integrated circuit (IC) are connected in a chip-on-glass (COG) package manner by using a conventional anisotropic conductive adhesive (ACA);

FIG. 2 is a sectional view illustrating misalignment between a glass substrate of an LCD panel and a driving IC connected in a COG package manner by using a conventional ACA;

FIG. 3 is a schematic view illustrating conductive particles and non-conductive particles dispersed in an ACA according to the present invention;

FIG. 4 is a flowchart for explaining a method of manufacturing an ACA according to the present invention; and

FIGS. 5A through 5D are sectional views for explaining a method of manufacturing a COG packaged LCD module according to an embodiment of the present invention.

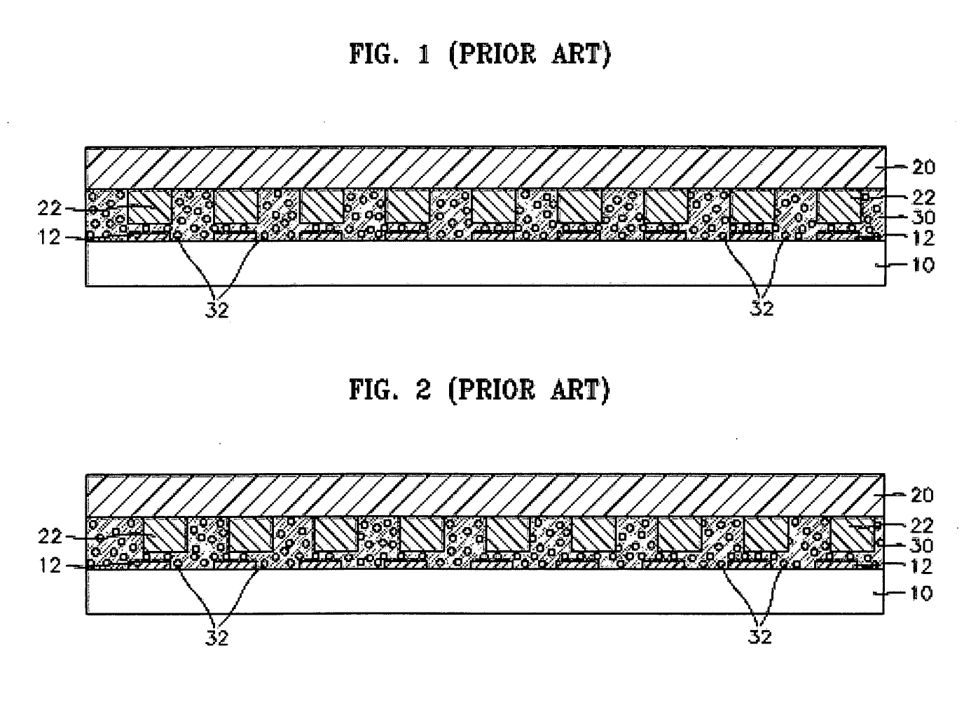

### DETAILED DESCRIPTION OF THE INVENTION

Preferred embodiments of the present invention will now be described with reference to the attached drawings.

An anisotropic conductive adhesive (ACA) according to the present invention is used for connecting an integrated circuit (IC), such as a driving IC, onto a glass substrate having a plurality of electrodes of a fine pitch, separated by a predetermined interval, so as to electrically connect the driving IC and the electrodes. Here, the viscosity of an adhesive resin is increased to stably connect the glass substrate and the IC and the ACA is formed of a composition for ensuring insulation between conductive particles to prevent the conductive particles from causing a short circuit. More specifically, the ACA according to the present invention includes a thermosetting resin and a curing agent for curing the thermosetting resin. Furthermore, in order to reliably transmit electrical signals between bumps of the driving IC and electrodes on the glass substrate at a low resistance, the ACA includes conductive particles having sizes smaller than half of a gap between the bumps of the driving IC and the electrodes, and preferably smaller than one third of the gap between the bumps of the driving IC and the electrodes. The conductive particles are metal powder or polymer beads coated with metal such as nickel or gold.

The ACA includes just enough conductive particles for obtaining a desired electrical resistance when the glass substrate and the IC are connected. Furthermore, in order to obtain a stable electrical conductivity, the conductive particles are dispersed in the ACA at a dispersion density of about twenty thousand to fifty thousand particles per mm², and preferably about thirty thousand particles per mm². For example, when an IC is connected to electrodes having a width of 30 μm and a pitch of 50 μm by using an ACA according to the present invention, and conductive particles are formed of metal-coated polymer beads having a diameter of about 4 μm, the ACA includes about 5 to 20 parts by weight, and preferably about 10 parts by weight, of the conductive particles based on the total weight of the ACA, so as to obtain a desired dispersion density.

In addition, in order to prevent the conductive particles from causing a short circuit, non-conductive particles having a diameter of less than half, preferably about half to one tenth, and most preferably one fifth, of the diameter of the conductive particles are dispersed in the ACA.

The non-conductive particles are formed of a material having a glass transition temperature that is higher than a temperature applied in an adhesion process, and sufficient hardness and elasticity to withstand a pressure applied in the adhesion process. Preferably, the non-conductive particles are formed of a polymer such as Teflon or polyethylene, or a ceramic such as alumina, silica, glass, or silicon carbide. Since the non-conductive particles have to be located between the conductive particles to prevent the conductive particles from causing a short circuit, the non-conductive particles have to be included in the ACA at a larger dispersion density than the conductive particles. In other words, there has to be more non-conductive particles than conductive particles in the ACA.

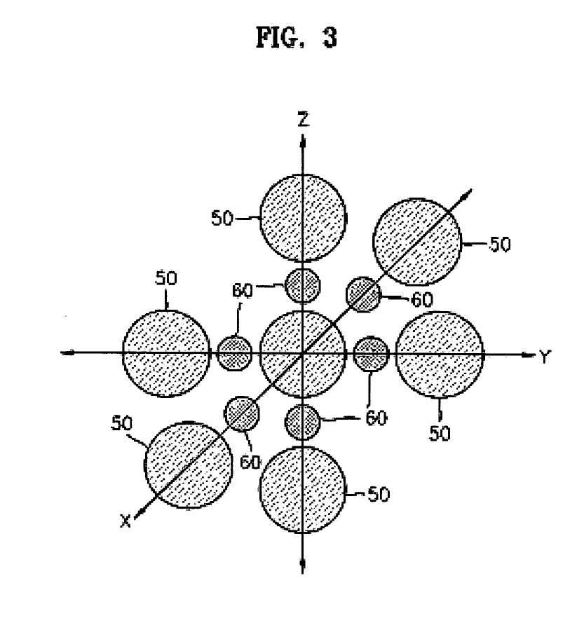

FIG. 3 is a schematic view illustrating conductive particles 50 and non-conductive particles 60 dispersed in an ACA according to the present invention. Referring to FIG. 3, when it is assumed that the conductive particles 50 and the non-conductive particles 60 are ideally dispersed in an ACA, each of the non-conductive particles 60 is located between adjacent conductive particles 50. Here, six non-conductive particles 60 surround each of the conductive particles 50. In other words, in order to completely prevent the conductive particles 50 from causing a short circuit, six non-conductive particles 60 are required for each of the conductive particles 50. However, when it is assumed that each of the non-conductive particles 60 is located between the conductive particles 50, three non-conductive particles 60 are required for each of the conductive particles 50 to prevent a short circuit from occurring. Accordingly, it is preferable that the number of the non-conductive particles 60 is as much as three times the number of the conductive particles 50 in an ACA.

Accordingly, the number of the non-conductive particles included in an ACA according to the present invention is at least two times, and preferably three to six times, as many as the number of the conductive particles. The dispersion density of the non-conductive particles in the ACA is forty thousand to three hundred thousand particles per mm² preferably about sixty thousand to one hundred and eighty thousand particles per mm², and most preferably about ninety thousand to one hundred and eighty thousand particles per mm². The number of the non-conductive particles per unit area is larger than the number of the conductive particles by about two to six times.

The following relations are used for deciding the amount of conductive particles and non-conductive particles in an ACA according to the present invention.
(Nc×2)≦Nn
Preferably, (Nc×3)≦Nn≦(Nc×6)

Here, Nc denotes the number of conductive particles and Nn denotes the number of non-conductive particles. The number of the conductive particles is calculated by dividing the total weight Wc of all of the conductive particles by the unit weight Wuc of a single conductive particle, i.e., Nc=Wc/Wuc. Here, the weight Wc of the conductive particles is decided from the ratio of the weight Wc of the conductive particles to the weight Wa of the ACA. Since the ratio of the weight Wc of the conductive particles to the weight Wa of the ACA is predetermined, the amount of the non-conductive particles is adjusted according to the kind and mass of the non-conductive particles, when the kind and mass of the conductive particles are decided. Here, in the case where the amount of the conductive particles is fixed, as the size of the particles decreases, the number of the particles increases so that electrical conductivity is improved. However, as the size of the particles decreases, the conductive particles become more likely to cause a short circuit, thus an appropriate size of the conductive particles has to be determined considering the electrical conductivity and the threshold for short circuiting. Since weights of the conductive particles and the non-conductive particles vary according to the nature and sizes of the particles, the amount of particles included in an ACA may vary. When the quantities of the conductive particles and the non-conductive particles are controlled according to the above relations, the conductive particles are prevented from causing a short circuit and electrical signals are stably transmitted.

Thermosetting resin for an ACA according to the present invention includes, for example, a solid epoxy resin such as bisphenol A, a liquid epoxy resin such as bisphenol F, a phenoxy resin, or a mixture thereof. Preferably, a mixture of bisphenol A, bisphenol F, and phenoxy resin at a mass ratio about 1:1 to 5:1 to 5 is used as a base resin.

Curing agent for an ACA according to the present invention includes, for example, an imidazole group derivative such as 2-methyl imidazole, 2-ethyl imidazole, 2-phenyl imidazole, or 1-cyanoethyl-2-methyl imidazole, an amide group derivative such as dicyandiamide, an amine derivative, an acid anhydride, or a phenol derivative. Here, the curing agent is added in an amount of about 20 to 50 parts by weight based on the weight of the epoxy resin.

In addition, a coupling agent can be added to the ACA according to the present invention. The coupling agent for the ACA according to the present invention includes, for example, a silane derivative such as 3-glycidylpromethoxysilane or 3-glycidyloxypropylmethyldiethoxysilane. Here, the coupling agent is added in an amount of about 2 to 4 parts by weight based on the weight of the epoxy resin.

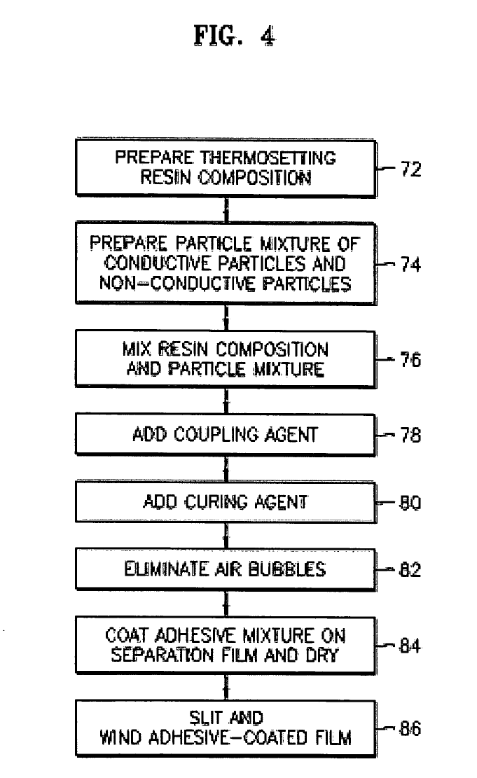

FIG. 4 is a flowchart for explaining a method of manufacturing an ACA according to a preferred embodiment of the present invention. In the preferred embodiment, a method of manufacturing a film-type ACA which is coated on a separation film is described; however, the present invention is not limited to the preferred embodiment and those skilled in the art may manufacture a paste type ACA or other various types of ACA based on the present invention.

Referring to FIG. 4, a resin composition used as a base resin for manufacturing an ACA according to the present invention is prepared in step 72. The base resin is formed of the resin composition including a solid epoxy resin, a liquid epoxy resin, and phenoxy resin in a mass ratio of 1:1 to 5:1 to 5. The resin composition is mixed with a solvent. A solvent for the solid epoxy resin is, for example, methylethylketone, and a solvent for the liquid epoxy resin is, for example, toluene.

It is preferable that the resin composition is formed of 10 parts by weight of a bisphenol A type solid epoxy, 13 parts by weight of a bisphenol F type liquid epoxy resin, and 23 parts by weight of the phenoxy resin, based on the total weight of the resin composition. Here, the resin composition is dissolved in a solvent formed of methylethylketone and toluene in a volume ratio of about 1:3 and mixed at room temperature for more than three hours.

Thereafter, a particle mixture formed of conductive particles and non-conductive particles required for manufacturing the ACA according to the present invention is prepared in step 74.

It is preferable that metal-coated polymer particles having an average diameter of about 4 μm are used as the conductive particles. Here, the content of the conductive particles is about 10 parts by weight based on the overall weight of the resin composition, the conductive particles, and the non-conductive particles. In addition, silica particles having an average diameter of about 0.8 μm are used as the non-conductive particles. The content of the non-conductive particles is about 20 parts by weight based on the overall weight of the resin composition, the conductive particles, and the non-conductive particles. Here, the density of the silica particles is 2.65 g/cm² and the density of the conductive particles is about 1 g/cm². Here, the number of the silica particles may be decreased in inverse proportion to the density of the silica particles. Nevertheless, the numbers of the silica particles can be increased by reducing the diameters of the particles. When the particle composition is prepared according to the above described conditions, there are theoretically 3.77 times as many non-conductive particles as conductive particles.

After preparing the particle composition according to the above-described conditions, the particle composition and the resin composition obtained in step 72 are physically mixed at room temperature for about 2 to 4 hours in step 76.

Thereafter, a coupling agent is added to the mixture of step 76 in step 78. Here, various silane derivatives such as 3-glycidylpromethoxysilane and 3-glycidyloxypropylmethyldiethoxysilane are used as the coupling agent, and about 2 to 4 parts by weight, and preferably 4 parts by weight, of the coupling agent, based on the weight of the resin composition, is added.

A curing agent is added to the resultant composition in step 80. The curing agent includes, for example, an imidazole group derivative such as 2-methyl imidazole, 2-ethyl imidazole, 2-phenyl imidazole, or 1-cyanoethyl-2-methyl imidazole, an amide group derivative such as dicyandiamide, an amine derivative, an acid anhydride, or a phenol derivative. Here, 20 to 50 parts by weight of the curing agent, based on the weight of the epoxy resin, is added. After the curing agent is added, the mixture is mechanically agitated at room temperature for about 0.5 to 3 hours.

The mixture obtained from step 80 may include air generated in mixing processes, thus air bubbles generated by the air included in the mixture are eliminated in step 82. In the case that the processes from steps 72 through 80 are performed in a vacuum, the process of eliminating the air bubbles may be omitted. However, it is preferable that the process of eliminating the air bubbles is performed.

The mixture from which air bubbles are eliminated is coated to a thickness of 23 μm or 25 μm on a separation film having a thickness of about 10 to 50 μm, and then dried at a temperature of about 70 to 80° C. for about 0.5 to 1 minute to form an adhesive film in step 84. Here, the separation film is formed of polyethyleneterephthalate (PET).

The separation film on which the adhesive film is formed is slit into a tape shape having a width of 1.5 to 5 mm and wound into rolls having a desired length, preferably 50 to 100 m, so as to complete a film-type ACA in step 86.

In the above-described ACA, when the conductive particles are metal particles, the unit mass of the non-conductive particles is smaller than that of the conductive particles. However, when metal-coated polymer particles are used as the conductive particles, the unit mass of the non-conductive particles may be greater than that of the non-conductive particles. Therefore, the contents of the conductive particles and the non-conductive particles in the mixture have to vary according to the weights or densities of the conductive particles and the non-conductive particles to be used in the ACA.

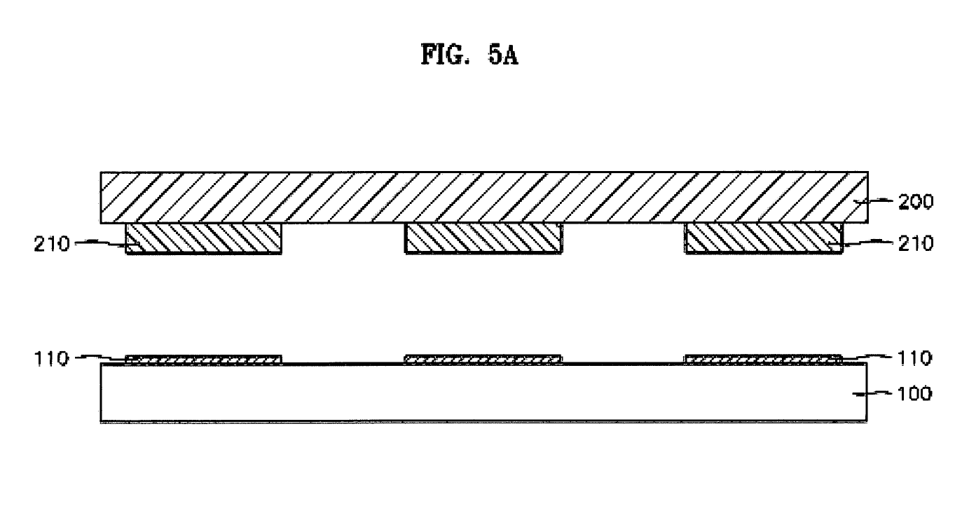

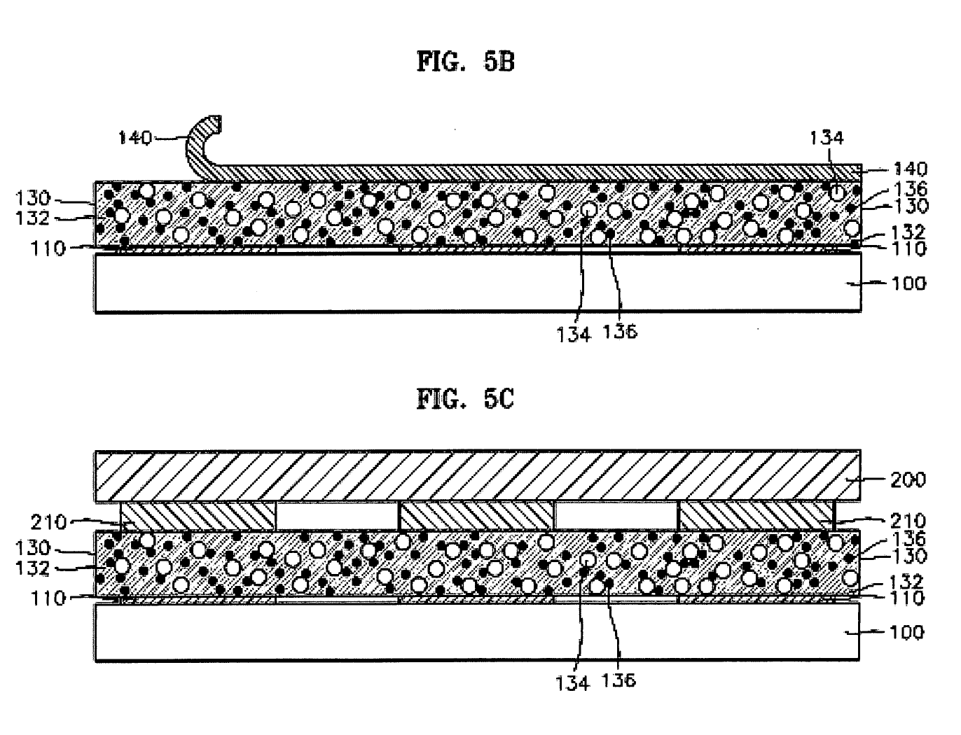

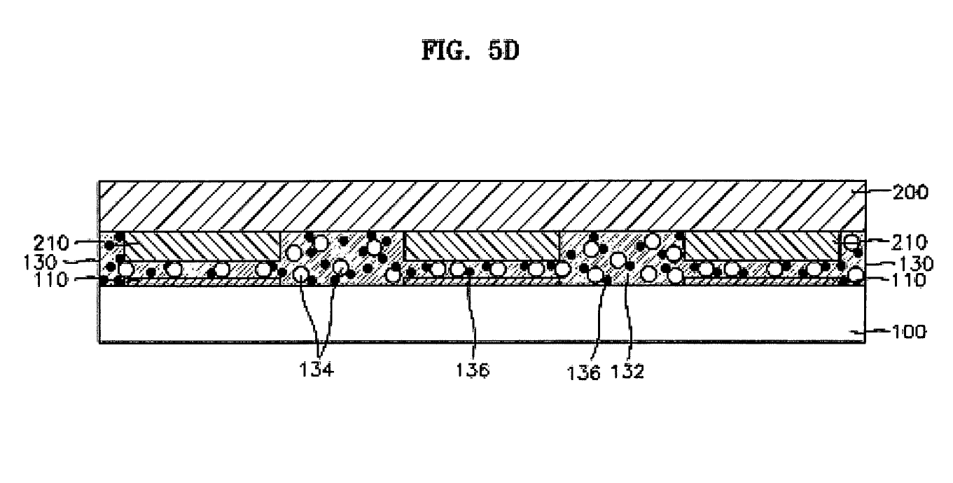

FIGS. 5A through 5D are sectional views for explaining a method of manufacturing a COG packaged LCD module according to an embodiment of the present invention.

Referring to FIG. 5A, a transparent glass substrate 100 on which indium tin oxide (ITO) electrodes 110 are arranged with a predetermined interval is prepared. The electrodes 110 have a height of about 1 μm, a width of about 30 μm, and a pitch of about 50 μm. Accordingly, the interval between the electrodes 110 is about 20 μm.

A driving IC 200 having input/output (I/O) bumps 210 is prepared. Here, the I/O bumps 210 are formed of electroless nickel/gold (Ni/Au) plated bumps formed on aluminum (Al) electrodes (not shown) of the driving IC 200. In this case, the electroless Ni/Au plated bumps are a substitute for expensive Au bumps. To this end, a zincate process is performed to substitute zinc (Zn) for portions of the Al electrodes of the driving IC 200 so that the Al electrodes become reactive in a Ni plating process. Here, the zincate process for the Al electrodes is performed as follows. Native oxide layers are eliminated from the surfaces of Al electrodes and the Al electrodes are dipped in a Zn solution for several seconds. The Al electrodes are withdrawn from the Zn solution and cleaned. The processes are repeated a plurality of times, and preferably two to three times. By repeating the above processes many times, an even and fine Zn atom bond is obtained on the surfaces of the Al electrodes. Thereafter, Ni bumps are formed on the zincate processed Al electrodes by an electroless plating method, and a Au plating process is performed on the Ni surfaces by the electroless plating method to form the electroless Ni/Au plated bumps. The I/O bumps 210 have a height of less than 25 μm and a pitch of about 50 μm.

Referring to FIG. 5B, an ACA 130 coated on a separation film 140 manufactured by the method described with reference to FIG. 4 is aligned on the glass substrate 100 having the electrodes 110. A temperature of about 70 to 90° C. and a pressure of about 3 to 10 kg_{f}/cm² are applied to the ACA 130 for about 3 to 5 seconds to temporarily press the ACA 130. As described above with reference to FIG. 4, the ACA 130 includes a resin composition 132, conductive particles 134, and non-conductive particles 136. Thereafter, the separation film 140 is removed from the temporarily pressed ACA 130.

Referring to FIG. 5C, the driving IC 200 is aligned on the temporarily pressed ACA 130 so that the I/O bumps 210 correspond to the electrodes 110.

Referring to FIG. 5D, the aligned glass substrate 100 and driving IC 200 are substantially pressed by applying a temperature of about 190 to 220° C. and a pressure of 500 to 1500 kg_{f}/cm² for about 5 to 10 seconds. The pressed resultant structure is cooled at room temperature without pressure in a cooling stage.

Accordingly, in a COG packaged LCD module according to the present invention, a large number of conductive particles 134 between the electrodes 110 of a fine pitch and I/O bumps 210 transmit electrical signals due to the small diameter of the conductive particles 134, and thus the electrical conductivity of the COG packaged LCD module is improved. In addition, non-conductive particles 136 are located between the conductive particles 134 in an ACA 130 so that the conductive particles 134 are prevented from causing a short circuit.

An anisotropic conductive adhesive (ACA) according to the present invention for connecting an integrated circuit (IC) onto a glass substrate having a plurality of electrodes of a fine pitch, to electrically connect the IC and the electrodes, includes a thermosetting resin, a curing agent for curing the thermosetting resin, a plurality of conductive particles having an average diameter of less than half of a gap between the IC and the electrodes and being included a first dispersion density, and a plurality of non-conductive particles having an average diameter of less than half of the average diameter of the conductive particles and being included at a second dispersion density that is larger than the first dispersion density. In a chip-on-glass (COG) packaged liquid crystal display (LCD) module according to the present invention, a large number of conductive particles between the electrodes of a fine pitch and input/output (I/O) bumps transmit electrical signals, due to the small diameter of the conductive particles, so that the electrical conductivity of the COG packaged LCD module is improved. In addition, non-conductive particles are located between the conductive particles in the ACA so that the conductive particles are prevented from causing a short circuit.

Accordingly, a driving IC can be stably and reliably connected onto an LCD panel having a large size and fine electrodes, by using an ACA according to the present invention. In addition, the present invention provides a COG packaged LCD module in which the LCD panel having electrodes of a fine pitch and the driving IC for driving an LCD device are stably and reliably connected without possibility of conductive particles causing a short circuit.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An anisotropic conductive adhesive (ACA) for fine pitch, used to connect an integrated circuit (IC) onto a glass substrate having a plurality of electrodes arranged with a predetermined interval and electrically connect the IC to the electrodes, the ACA comprising:
a thermosetting resin;
a curing agent for curing the thermosetting resin;
a plurality of conductive particles having an average diameter of less than half of a gap between the electrodes of the glass substrate, the plurality of conductive particles being included at a first dispersion density; and
a plurality of non-conductive particles having an average diameter of less than half of the average diameter of the conductive particles, the plurality of non-conductive particles being included at a second dispersion density that is larger than the first dispersion density.

2. The ACA for a fine pitch of claim 1, wherein the conductive particles have an average diameter of less than one third of the gap between the electrodes of the glass substrate.

3. The ACA for a fine pitch of claim 1, wherein the non-conductive particles have an average diameter of half to one tenth of the average diameter of the conductive particles.

4. The ACA for a fine pitch of claim 1, wherein the first dispersion density is twenty thousand to fifty thousand particles per mm², and the second dispersion density is sixty thousand to one hundred and eighty thousand particles per mm².

5. The ACA for a fine pitch of claim 1, wherein the second dispersion density is two to six times greater than the first dispersion density.

6. The ACA for a fine pitch of claim 1, wherein the non-conductive particles are formed of a polymer or a ceramic.

7. The ACA for a fine pitch of claim 6, wherein the non-conductive particles are formed of one material selected from the group consisting of Teflon, polyethylene, alumina, silica, glass, and silicon carbide.

8. A chip-on-glass (COG) packaged liquid crystal display (LCD) module comprising:
a transparent glass substrate having a plurality of electrodes arranged with a predetermined interval;
a driving integrated circuit (IC) having input/output (I/O) bumps arranged to correspond the electrodes;
an ACA interposed between the glass substrate and the driving IC to adhere the glass substrate and the driving IC;
a plurality of conductive particles having an average diameter of less than half of a gap between the electrodes, the plurality of conductive particles being included at a first dispersion density to maintain electrical connection between the electrodes and the I/O bumps, and
a plurality of non-conductive particles having an average diameter of less than half of the average diameter of the conductive particles, the plurality of non-conductive particles being included at a second dispersion density which is larger than the first dispersion density.

9. The COG packaged LCD module of claim 8, wherein the conductive particles have an average diameter of less than one third of the gap between the electrodes.

10. The COG packaged LCD module of claim 8, wherein the non-conductive particles have an average diameter of half to one tenth of the average diameter of the conductive particles.

11. The COG packaged LCD module of claim 8, wherein the first dispersion density is twenty thousand to fifty thousand particles per mm², and the second dispersion density is sixty thousand to one hundred and eighty thousand particles per mm².

12. The COG packaged LCD module of claim 8, wherein the second dispersion density is two to six times greater than the first dispersion density.

13. The COG packaged LCD module of claim 8, wherein the non-conductive particles are formed of a polymer or a ceramic.

14. The COG packaged LCD module of claim 13, wherein the non-conductive particles are formed of one material selected from the group consisting of Teflon, polyethylene, alumina, silica, glass, and silicon carbide.

15. The COG packaged LCD module of claim 8, wherein the electrodes on the glass substrate have a fine pitch of less than 50 μm.
